(19) United States
(12) Patent Application Publication
(10) Pub. No.: US 2012/0232975 A1
(43) Pub. Date: Sep. 13, 2012

(54) METHOD AND SYSTEM FOR PROVIDING MOVING-IMAGE ADVERTISEMENTS AND COUPONS USING VOICE OVER INTERNET PROTOCOL

(76) Inventor: Munjun Hwang, Gyeonggi-do (KR)

(21) Appl. No.: 13/260,264

(22) PCT Filed: May 23, 2011
(86) PCT No.: PCT/KR2011/003757

§ 371 Date: Sep. 24, 2011

(30) Foreign Application Priority Data
Mar. 11, 2011 (KR) 10-2011-0022093

(51) Int. Cl. G06Q 30/02

(52) U.S. Cl. 705/14.23; 705/14.39

(57) ABSTRACT

The present invention relates to a method of providing moving-image advertisements and coupons using VoIP. The present invention provides a method of providing moving-image advertisements and coupons using Voice over Internet Protocol (VoIP). According to the above-described present invention, advertisements for products are provided in the form of moving images in a video call reception standby state, so that users can ascertain the content of the advertisements and the drawing of the attention of users towards the moving-image advertisements is increased, thereby maximizing the effects of the advertisements and also promoting the purchasing of products. A user and his or her counter party can be provided with coupons while on a video call, so that a minimum number of persons for cooperative buying can be easily achieved.

### TECHNICAL FIELD

The present invention relates generally to a method of providing moving-image advertisements and coupons using VoIP and, more particularly, to a method and system for providing moving-image advertisements and coupons using VoIP, which enable users to view moving-image advertisements during call setup attempts.

### BACKGROUND ART

The present invention relates to a method and system for providing advertisements over the Internet. Currently, a variety of types of on-line advertisement systems are being provided to promote the inflow of users to on-line websites. Most of these advertisement systems are configured such that banner advertisements are displayed on Internet screens and access is made to advertisers' websites via hyperlinks when the banner advertisements are clicked. However, this method is disadvantageous in that it is difficult to achieve actual advertising effects because it is difficult to urge users to click the banner advertisements.

In particular, moving-image advertisements are disadvantageous in that it is difficult to urge users to concentrate on the content of the moving-image advertisements even when they are displayed on Internet web pages.

Furthermore, they are disadvantageous in that they inconvenience users because there are not any sufficient means for enabling the target products or services of advertisements to be directly purchased even when the users access the advertisements.

### DISCLOSURE

### Technical Problem

Accordingly, the present invention has been made keeping in mind the above problems occurring in the prior art, and an object of the present invention is to provide a method and system for providing moving-image advertisements and coupons using VoIP, which provide advertisements for products using VoIP in the form of moving images, thereby enabling users to accurately become aware of the content of the advertisements without requiring additional action.

Another object of the present invention is to provide a method and system for providing moving-image advertisements and coupons using VoIP, which provide advertisements using a call connection standby period video during a call attempt in order to maximize the drawing of the attention of users towards the moving-image advertisements.

A further object of the present invention is to provide a method and system for providing moving-image advertisements and coupons using VoIP, which provide coupons for buying products, the coupons being related to the moving-image advertisements, thereby simplifying a product buying procedure.

Yet another object of the present invention is to provide a method and system for providing moving-image advertisements and coupons using VoIP, which enable a user and his or her counter party to simultaneously view a product-related advertisement while on a video call with each other, thereby maximizing the advertising effect of the advertisement, and which provide a coupon for buying a product at a discounted price in real time while a user is viewing an advertisement.

### Technical Solution

In order to accomplish the above objects, the present invention provides a method of providing moving-image advertisements and coupons using VoIP, the method being performed by a server for providing moving-image advertisements and coupons to a plurality of user terminals capable of a video call using VoIP, the method including the steps of (a) when a video call attempt signal is received from a user terminal, sending a moving-image advertisement to the user terminal; (b) sending coupon data about a cooperative buying coupon corresponding to the moving-image advertisement sent at step (a); (c) when a signal indicative of selection of the cooperative buying coupon corresponding to the moving-image advertisement sent at step (a) is received from the user terminal, registering the cooperative buying coupon selected by the user terminal in a user account assigned to the user terminal; (d) when a video call setup signal is received from the user terminal, terminating the sending of the moving-image advertisement; and (e) when cooperative buying related to the cooperative buying coupon registered in the user account is accomplished, notifying the user terminal of the accomplishment of the cooperative buying.

The method may further include the steps of (f) when a video call termination signal is received from the user terminal, sending the coupon data about the cooperative buying coupon registered in the user account at step (c) to the user terminal; and (g) when information about a payment for the cooperative buying coupon is received from the user terminal, completing the payment by performing a payment procedure based on the payment information, and sending coupon payment completion information to the user terminal.

The method may further include the step of (h) when the video call setup signal is received from the user terminal at step (d) and then a signal requesting the moving-image advertisement or the cooperative buying coupon to be shared with another user terminal, that is, a counter party of the video call, is received from the user terminal, sending the moving-image advertisement sent at step (a) or the coupon data sent at step (b) to the other user terminal.

Step (a) may include (a1) when a video call attempt signal is received from the user terminal, searching user accounts corresponding to identification information of the user terminal and identification information of another user terminal, that is, a counter party of the video call, included in the video call attempt signal; (a2) searching for a moving-image advertisement corresponding to at least one of an age, a vocation, a field of interest, a place of residence and a country of residence included in user information corresponding to the searched user accounts; and (a3) sending the retrieved moving-image advertisement to the user terminal.

In order to accomplish the above objects, the present invention provides a method of providing moving-image advertisements and coupons using Voice over Internet Protocol (VoIP), the method being performed by a server for providing moving-image advertisements and coupons to a plurality of user terminals capable of a video call using VoIP, the method including the steps of (A) when a user's video call attempt is sensed, sending a video call attempt signal to the server; (B) when a moving-image advertisement and coupon data about a cooperative buying coupon corresponding to the moving-image advertisement are received from the server, displaying the moving-image advertisement and the cooperative buying coupon; (C) when the cooperative buying coupon is selected, sending a signal indicative of the selection of the cooperative buying coupon to the server; (D) when video call setup is sensed, sending a video call setup signal to the server, stopping the displaying of the moving-image advertisement and the cooperative buying coupon at step (B), and displaying a call video sent by a communication service provider server; (E) when termination of the video call is sensed, sending a video call termination signal to the server; and (F) when a notification of accomplishment of cooperative buying related to the cooperative buying coupon selected at step (C) is received from the server, displaying the notification of accomplishment of cooperative buying.

Step (C) may include the step of, when the cooperative buying coupon is selected, storing coupon data about the selected cooperative buying coupon in the user terminal.

Step (D) may include the steps of displaying a button for sharing the moving-image advertisement or the cooperative buying coupon corresponding to the moving-image advertisement on one side of the call video while displaying the call video; and when the button for sharing the moving-image advertisement or the cooperative buying coupon corresponding to the moving-image advertisement is selected, sending a signal requesting the moving-image advertisement or the cooperative buying coupon to be shared, including identification information of another user terminal to which a video call is set up, to the server.

Step (D) may include the steps of displaying a moving-image advertisement sharing button on one side of the call video while displaying the call video; when the moving-image advertisement sharing button is selected, sending a moving-image advertisement sharing request signal, including identification information of another user terminal to which a video call is set up, to the server; and when the moving-image advertisement displayed at step (B) is sent from the server in response to the sharing request signal, receiving and displaying the sent moving-image advertisement.

Step (F) may include the steps of, when a cooperative buying accomplishment notification related to the cooperative buying coupon selected at step (C) is received from the server, displaying a payment window for receiving payment information for the cooperative buying coupon for which the cooperative buying has been accomplished; and receiving the payment information using the payment window, and sending the payment information to the server.

In order to accomplish the above objects, the present invention provides a server for providing moving-image advertisements and coupons to a plurality of user terminals capable of a video call using VoIP, the server including an advertisement provision unit for providing a moving-image advertisement to the user terminal when a video call attempt signal is sent by the user terminal, and stopping the provision of the moving-image advertisement when a video call setup signal is sent; a coupon provision unit for searching for a cooperative buying coupon corresponding to the moving-image advertisement provided to the user terminal by the advertisement provision unit, and sending coupon data about the retrieved cooperative buying coupon to the user terminal; and a user information management unit for registering the selected cooperative buying coupon in a user account assigned to the user terminal when the user terminal receives a signal indicative of selection of the cooperative buying coupon.

The server may further include an advertisement DB for storing a plurality of moving-image advertisements; a coupon DB for storing coupon data about cooperative buying coupons respectively corresponding to the plurality of moving-image advertisements stored in the advertisement DB; and a user DB for storing user information of user accounts respectively assigned to the user terminals.

The advertisement provision unit may select a moving image advertisement to be sent to the user terminal from the advertisement DB, based on user information of user accounts respectively corresponding to identification information of a sending user terminal and identification information of a receiving user terminal included in the video call attempt signal.

The coupon data stored in the coupon DB may include at least part of identification information of the moving-image advertisement corresponding to the cooperative buying coupon, a product price, a discount rate, a cooperative buying condition, a coupon use condition, the number of currently issued coupons, the identification number of the coupon, and the validity period of the coupon.

The advertisement provision unit may send the moving-image advertisement, provided when the video call attempt signal is received, or the coupon data about the cooperative buying coupon corresponding to the moving-image advertisement, provided when the video call attempt signal is received, to the user terminal when a video call termination signal is received from the user terminal.

### Advantageous Effects

In accordance with the method and system for providing moving-image advertisements and coupons using VoIP according to the present invention, the following advantages can be achieved.

That is, during an attempt to make a video call to another terminal using VoIP, advertisements of products may be provided in the form of moving images, so that there is the advantage of enabling users to ascertain the content of the advertisements.

Furthermore, in accordance with the method and system for providing moving-image advertisements and coupons using VoIP according to the present invention, advertisements are provided using call connection standby periods during video call attempts, and therefore the drawing of the attention of users towards the advertisements can be increased, so that there is the advantage of maximizing the effects of the advertisements.

Furthermore, in accordance with the method and system for providing moving-image advertisements and coupons using VoIP according to the present invention, product buying coupons related to moving-image advertisements are provided and therefore the product buying procedure is simplified, so that there is the advantage of promoting the buying of products of consumers.

Moreover, in accordance with the method and system for providing moving-image advertisements and coupons using VoIP according to the present invention, a user and his or her counter party can simultaneously view advertisements of products while on a video call with each other, so that there is the advantage of maximizing the advertising effects, and coupons at discounted prices are provided to counter parties, so that there is the advantage of easily achieving a minimum number of persons for cooperative buying.

### DESCRIPTION OF DRAWINGS

FIG. 1 is a diagram schematically showing the overall configuration of a system for providing moving-image advertisements and coupons using VoIP according to an embodiment of the present invention;

FIG. 2 is a block diagram illustrating an advertisement server according to an embodiment of the present invention;

FIG. 3 is a block diagram illustrating the configuration of a user terminal according to an embodiment of the present invention;

FIG. 4 is a flowchart illustrating a method of providing moving-image advertisements and coupons using VoIP in steps; and

FIGS. 5 and 6 are diagrams showing examples of the system and method for providing moving picture advertisements and coupons using VoIP according to the embodiments of the present invention.

### MODE FOR INVENTION

A system and method for providing moving-image advertisements and coupons using VoIP according to embodiments of the present invention will be described in detail below with reference to the accompanying drawings. The advantages and features of the present invention and methods of achieving those will be apparent by reference to the embodiments which will be described in detail below in conjunction with the accompanying drawings.

The present invention is not limited only to embodiments which will be disclosed below, but may be implemented in a variety of forms. The present embodiments are provided to make the disclosure of the present invention complete and to fully notify those having ordinary knowledge in the art to which the present invention pertain of the scope of the present invention. The present invention is defined merely by the scope of the claims.

The same reference numerals designate the same elements throughout the entire specification.

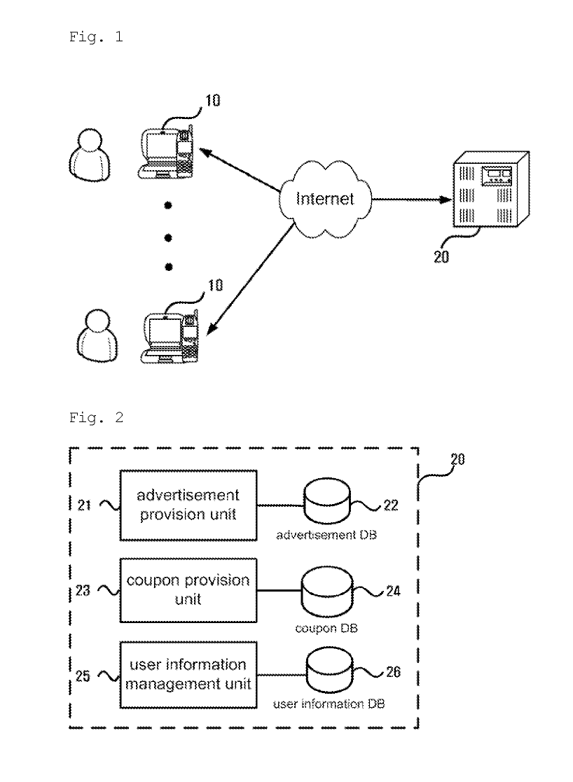

FIG. 1 is a diagram schematically showing the overall configuration of a system for providing moving-image advertisements and coupons using VoIP according to an embodiment of the present invention. VoIP is technology for sending and receiving voice signals over the Internet, and sends voice over an IP (Internet Protocol) network, which is the core of the Internet, in the form of packets, unlike existing circuit switched telephony. A representative example of solutions for technology for communicating data over the Internet or sending voice data over an IP network is an ‘Internet phone.’ Internet phones enable voice calls to be made over the Internet, and send voice and data via a single network, thereby improving the network efficiency and providing various intelligent network services related to the Internet. Furthermore, Internet phones have the advantage of inexpensively making long-distance calls, such as out-of-town calls and international calls, and recently provide the service of making a video call or holding a conference while a plurality of persons is facing one another at the same time.

The configuration of the system for providing moving-image advertisements and coupons using VoIP, which provide moving-image advertisements and coupons related to products to user terminals, that is, for example, Internet phones, will be schematically described below.

As shown in FIG. 1, the system for providing moving picture advertisements and coupons using VoIP according to an embodiment of the present invention includes a plurality of user terminals 10. The user terminals 10 are Internet phones that are capable of exchanging video, audio and text data with counterparts using VoIP, as described above. In contrast, in this embodiment of the present invention, the user terminals 10 are provided with image output means, such as Liquid Crystal Displays (LCDS), which are capable of outputting moving-image advertisements. The configuration of the user terminals 10 will be described in detail later.

Furthermore, the user terminals 10 exchange data with an advertisement server 20 over the Internet. The advertisement server 20 is a server of an Internet Service Provider (ISP) that provides moving-image advertisements and their cooperative buying coupons over the Internet, and provides the services of sending a variety of types of moving-image advertisements to the plurality of user terminals 10 and issuing cooperative buying coupons corresponding to the moving-image advertisements, thereby enabling users to buy products related to the advertisements at low prices.

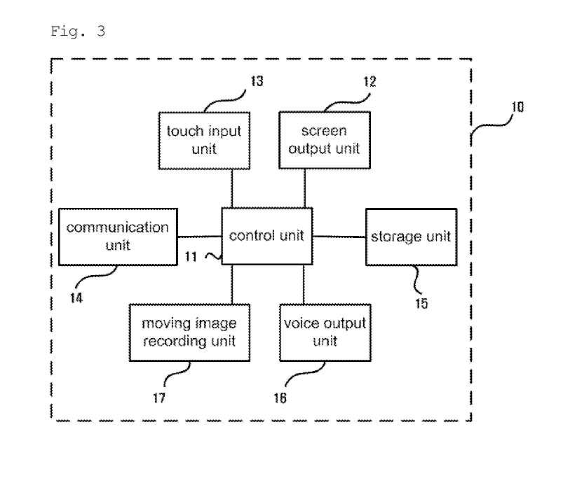

The detailed configuration of the advertisement server 20 will be shown in FIG. 2. FIG. 2 is a block diagram illustrating an advertisement server according to an embodiment of the present invention.

As shown in the drawing, the advertisement server 20 includes an advertisement provision unit 21 for providing moving-image advertisements when a signal is received from each of the user terminals 10, and an advertisement DB 22 for storing the moving-image advertisements provided by the advertisement provision unit 21.

When an attempt to make a video call in which the user terminals 10 exchange images being recorded in real time with each other is sensed and a call attempt signal sent to the advertisement server 20 is received, the advertisement provision unit 21 functions to search the advertisement DB 22 for appropriate moving-image advertisements based on user information stored in user accounts assigned to a sending user terminal 10 having sent the call attempt signal and a receiving user terminal 10 targeted by the call attempt, to extract the appropriate advertisements, and to transfer the image packets of the extracted moving-image advertisements to the sending user terminal 10.

Furthermore, the advertisement DB 22 stores moving-image advertisements for the respective ages, vocations and fields of interest of consumers who are the advertising targets of the moving-image advertisements, for respective types and prices of the target products of the advertisements, for respective pieces of content of the advertisements, and for respective regions or countries targeted by the advertisements, so that the advertisement provision unit 21 can retrieve the appropriate advertisements from the advertisement DB 22 based on sender information or receiver information.

Furthermore, the advertisement server 20 is provided with a coupon provision unit 23. The coupon provision unit 23 functions to provide coupon data about cooperative buying coupons, corresponding to the moving-image advertisements, stored in the coupon DB 24, to the user terminals 10. In this case, the coupon provision unit 23 provides stored cooperative buying coupons to the user terminal 10 in response to the moving-image advertisements selected by the advertisement provision unit 21 and, therefore, on the user terminal 10, moving-image advertisements provided by the advertisement provision unit 21 are displayed and at the same time the cooperative buying coupons of products related to the moving-image advertisements are displayed on one side thereof, so that the users of the user terminals 10 are able to immediately select coupons while viewing advertisements when being interested in related products. Here, the cooperative buying coupons are electronic tickets that provide the rights to cooperatively buy products related to moving-image advertisements at discounted prices. Users who are issued with the cooperative buying coupons can pay the prices of the products registered in the cooperative buying coupons using the cooperative buying coupons, and can buy the products corresponding to the cooperative buying coupons when a cooperative buying condition is satisfied (for example, when the number of persons participating in cooperative buying is equal to or larger than a set number). In this case, the sequence of the payment of the price of a product and the satisfaction of the cooperative buying condition may be reversed.

The coupon data about the cooperative buying coupons corresponding to the moving-image advertisements stored in the advertisement DB 22 is stored in the coupon DB 24, and coupon data about each of the cooperative buying coupons may also include the identification information of a moving-image advertisement corresponding to the cooperative buying coupon, a product price, a discount rate, a cooperative buying condition, a coupon use condition, the number of currently issued coupons, the identification number of the coupon, and the validity period of the coupon.

The advertisement server 20 further includes a user information management unit 25. The user information management unit 25 functions to manage user information stored in user accounts registered in the user DB 26. Here, user accounts may be opened for respective individuals, as in a general Internet service, or for respective pieces of identification information of the user terminals 10. Meanwhile, the user information is received from the user terminals 10 or separate Internet accessible information processing terminals, and is separately stored in respective user accounts. For example, the user information may include a user name (in the case where a plurality of users shares a user terminal 10, the name of a representative), a mobile phone number, an address, a vocation, a hobby, a field of interest, an age, and/or a place of residence. The user information management unit 25 stores such user information in a corresponding user account when the user information is input, and, in particular, manages the details of the moving-image advertisements and cooperative buying coupons provided by the advertisement provision unit 21 or the coupon provision unit 23 to the user terminals 10. That is, for example, the details of viewed moving-image advertisements, a list of moving-image advertisements selected as advertisements of interest, the details of selected coupons, and/or the details of payments related to coupons are stored in a user account assigned to each of the user terminals 10, and, whenever a change is made to these details, information about the details is updated and provided to the user terminal 10.

These components of the server are communicatively connected to one another, and the steps of the operation thereof will be described later.

The detailed configuration of the user terminal 10 will now be described. FIG. 3 is a block diagram illustrating the configuration of the user terminal according to an embodiment of the present invention. As shown in FIG. 3, the user terminal 10 according to an embodiment of the present invention first includes a control unit 11. The control unit 11 is common control means included in an information processing device, and generally controls the user terminal 10 in compliance with an Operation System (OS) and performs application functions of the user terminal 10 in compliance with a variety of types of programs.

The control unit 11 displays moving-image advertisements and cooperative buying coupons, sent by the advertisement server 20, on the screen output unit 12. The screen output unit 12 is a common image output device, and may be formed of, for example, an LCD display. During a video call, the screen output unit 12 displays images from a counter party's user terminal 10 which are recorded in real time and received from a communication service provider server (not shown in the drawings) operated by a communication service provider, and displays moving-image advertisements and cooperative buying coupons provided by the advertisement server 20 when needed.

A touch input unit 13 is formed on the screen output unit 12. The touch input unit 13 calculates the coordinates of a portion where a user's touch input is sensed, and sends the coordinate information to the control unit 11. Accordingly, the control unit 11 executes a command which was assigned to an item displayed at a location corresponding to the coordinates of the screen output unit 12 where the touch input was sensed.

Furthermore, the user terminal 10 includes a communication unit 14 that exchanges data with the other user terminals 10 via the communication service provider server, and exchanges data with the advertisement server 20 as well.

Furthermore, a storage unit 15 that stores a variety of types of information necessary for the operation of the user terminal 10 is further included. In this case, the moving-image advertisement or coupon information and user information provided by the advertisement server 20 may be temporarily or semi-permanently stored in or deleted from the storage unit 15.

Furthermore, the user terminal 10 includes a voice output unit 16. The voice output unit 16 is a voice output device, such as a speaker, which outputs voice data included in moving-image advertisements sent by the advertisement server 20 or voice data sent via the communication service provider server by the other user terminals 10.

The user terminal 10 further includes a moving image recording unit 17. During a video call, the moving image recording unit 17 creates moving image data by recording images of an area around the user terminal 10 and the voice, and sends the moving image data to the communication service provider server, so that the moving image data is sent to the counter party's user terminal 10 of the video call, thereby enabling the video call.

The above components of the user terminal 10 are communicatively connected to one another, and the steps of the operation thereof will be described later.

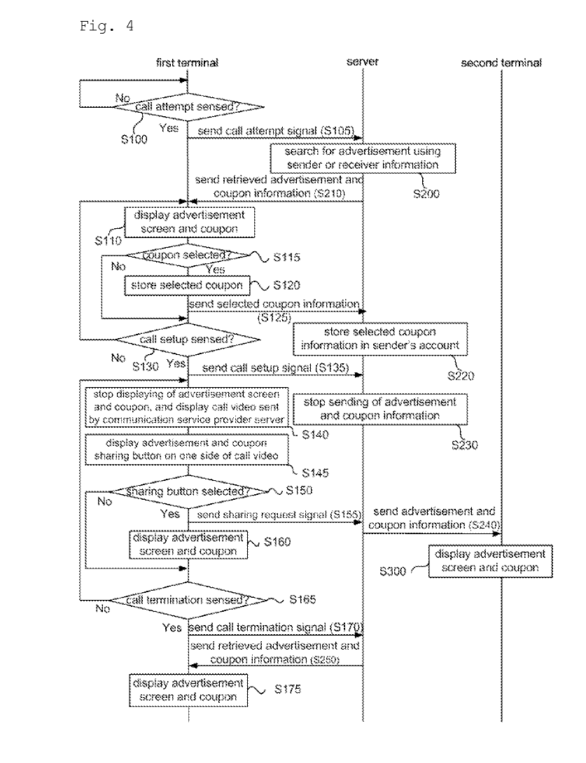

A method of providing moving-image advertisements and coupons using a system for providing moving-image advertisements and coupons including the above-described user terminal 10 and advertisement server 20 will be described in detail with reference to FIG. 4. FIG. 4 is a flowchart illustrating the method of providing moving-image advertisements and coupons using VoIP in steps.

In the following description of the method of providing moving-image advertisements and coupons, the description will be given with the sending user terminal 10 of a video call being referred to as a ‘first user terminal’ and the receiving user terminal 10 being referred to as a ‘second user terminal.’

In the embodiment of the present invention, first the step of monitoring whether the first user terminal attempts a video call to the advertisement server 20 is performed at step S100. When a command to set up a video call to a second user terminal is input by a user, the first user terminal senses the command as a video call attempt, and transfers a call attempt signal to the advertisement server 20 at step S105. Here, the call attempt signal includes first user terminal identification information and second user terminal identification information corresponding to the sending and receiving user terminals 10, and information indicating that a video call attempt has been sensed.

When the call attempt signal has been received from the first user terminal, the advertisement provision unit 21 of the advertisement server 20 searches for a moving-image advertisement which will be sent from the advertisement DB 22 to the first user terminal at step S200.

In this case, although the advertisement server 20 may arbitrarily select a moving-image advertisement from the advertisement DB 22 and send it, the advertisement server 20 may search for a moving-image advertisement, corresponding to a sender or receiver's age, vocation, field of interest, place of residence and country of residence, based on the user information stored in a user account (hereinafter referred to as a ‘sender's account’), corresponding to the first user terminal, registered in the user DB 26 and in a user account (hereinafter referred to as a ‘receiver's account’), corresponding to second user terminal, registered in the user DB 26, using first user terminal identification information and second user terminal identification information included in the call attempt signal.

For example, when an Internet phone call is made from Korea to the U.S., it may be possible to retrieve a moving-image advertisement in the U.S. registered by an advertiser in the U.S. That is, the moving-image advertisement that is selected may vary depending on age, vocation, field-of-interest, place-of-residence and country-of-residence information that was registered in a sender or receiver's user account or acquired based on the sender or receiver's phone number.

Then the advertisement provision unit 21 extracts the retrieved moving-image advertisement and transfers the video packets of the moving-image advertisement to the first user terminal at step S210. In this case, the coupon provision unit 23 may read coupon data about a cooperative buying coupon, corresponding to the moving-image advertisement sent by the advertisement provision unit 21 to the first user terminal, from the coupon DB 24, and send the coupon data together with the moving-image advertisement to the first user terminal.

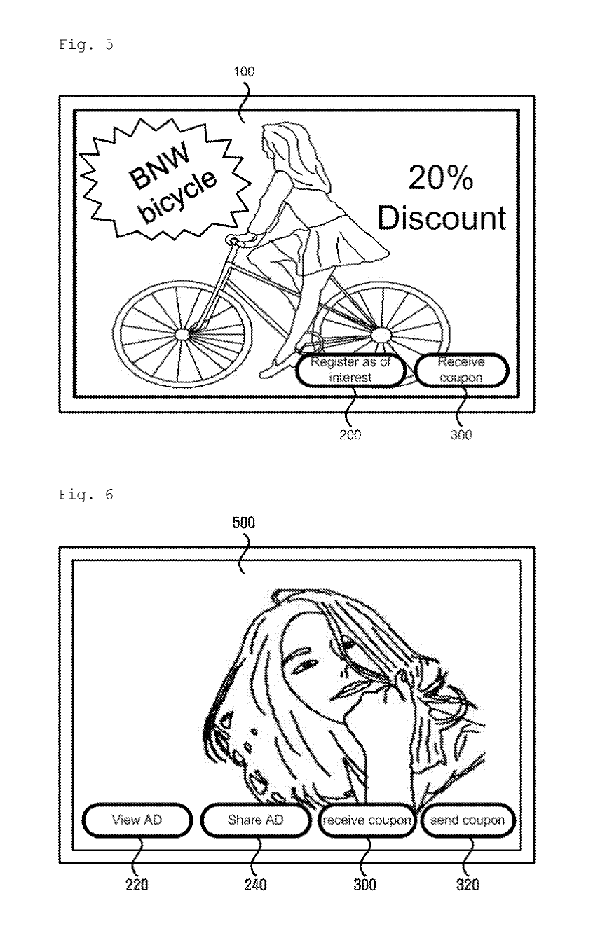

Accordingly, the first user terminal which has received the video packets of the moving-image advertisement and the coupon data about the cooperative buying coupon from the advertisement server 20 displays the moving-image advertisement and the coupon on the image output unit 12 at step S110. For example, as shown in FIG. 5a, a moving-image advertisement screen 100 is displayed on the entire image output unit 12, and an advertisement storage menu option 200 for registering a currently displayed moving image advertisement in an advertisement-of-interest list stored in the user account registered in the user DB 26 and a cooperative buying coupon 300 corresponding to the currently displayed moving-image advertisement may be displayed on one side of the moving-image advertisement screen 100. In this case, although the cooperative buying coupon may be displayed in a manner that allows detailed information included in the coupon data to be described, it may be displayed in the form of a simple button, as shown in the drawing.

Then, when the user of the first user terminal selects the cooperative buying coupon by applying touch input onto the region of the touch input unit 13 corresponding to the location of the image output unit 12 where the cooperative buying coupon 300 is displayed at step S115, the first user terminal senses the touch input and stores coupon data about the selected cooperative buying coupon in the storage unit 15 at step S120, and sends coupon selection information, such as the identification number of the selected cooperative buying coupon, to the advertisement server 20 via the communication unit 14 at step S125.

The advertisement server 20 receives the coupon selection information from the first user terminal, and registers information about the selected cooperative buying coupon in the selected coupon details of the sender account at step S220.

Meanwhile, when the coupon selection information is sent to the advertisement server 20 after the cooperative buying coupon has not been selected or has been selected, the first user terminal monitors whether a response to the video call attempt has been made by the second user terminal and therefore the video call has been set up at step S130.

If it is determined that the video call has been set up, the first user terminal sends a video call setup signal to the advertisement server 20 at step S135. When the video call setup signal is received from the first user terminal, the advertisement server 20 stops the provision of the moving-image advertisement and the cooperative buying coupon at step S230, and the first user terminal stops the display of the moving-image advertisement screen and the cooperative buying coupon and displays a call video recorded in the second user terminal and sent via the communication service provider server at step S140.

In this case, a button for sharing the previously displayed moving-image advertisement or a cooperative buying coupon corresponding to the moving-image advertisement with the receiver of the video call may be displayed on one side of the call video on the first user terminal. For example, as shown in FIG. 5b, a call video 500 is displayed on the entire image output unit 12 of the first user terminal, and an advertisement continuous view button 220 for displaying the moving-image advertisement, displayed in a call reception standby state before the setup of the video call, during a video call, an advertisement sharing view button 240 for sending the moving-image advertisement, displayed in the call reception standby state before the setup of the video call, to the second user terminal, a cooperative buying coupon 300 to be displayed in the case where the cooperative buying coupon was not been selected in the call reception standby state, and a coupon sending button 320 for sending the cooperative buying coupon, corresponding to the moving-image advertisement displayed in the call reception standby state, to the second user terminal may be displayed together on one side of the call video 500.

When the advertisement continuous view button 220 is selected, the moving-image advertisement displayed in the call reception standby state before the setup of the video call may be displayed on the entire area or one side of the image output unit 12 of the first user terminal.

When the sharing of the moving-image advertisement and its corresponding cooperative buying coupon with the second user terminal is selected, as in the case where the advertisement sharing view button 240 or coupon sending button 320 is selected at step S150, the first user terminal transfers a sharing request signal to the advertisement server 20 at step S155, and the advertisement server 20 sends a moving-image advertisement and a cooperative buying coupon, identical to the moving-image advertisement and its corresponding cooperative buying coupon provided to the first user terminal, to the second user terminal at step S240. Accordingly, the moving-image advertisement screen and the cooperative buying coupon may be also displayed on the image output unit 12 of the second user terminal at step S300, thereby enabling the receiver to select the cooperative buying coupon and buy a product using the cooperative buying coupon later.

In this case, the moving-image advertisement and its corresponding cooperative buying coupon may also be displayed on the first user terminal at step S160, which enables the sender and the receiver to have a voice conversation while viewing the same moving-image advertisement and to share information about a product which will be cooperatively bought, thereby increasing the advertising effect and the desire to make a purchase.

Meanwhile, when the termination of the video call is sensed at step S165, the first user terminal sends a video call termination signal to the advertisement server 20 at step S170, and the advertisement server 20 provides the moving-image advertisement and its corresponding cooperative buying coupon provided in the call reception standby state at step S250, so that a user can check the content of the moving-image advertisement and coupon data about the cooperative buying coupon on the first user terminal in detail at step S175. Accordingly, the user is allowed to check the content of the moving-image advertisement and participate in the cooperative buying after the termination of the call.

Meanwhile, after step S175, the advertisement server 20 notifies the first user terminal of the satisfaction of a cooperative buy condition via Short Message Service (SMS) when the cooperative buying condition corresponding to the cooperative buying coupon selected by the first user terminal at step S115 is satisfied (if a cooperative buying condition for the cooperative buying coupon included in the details of the selected coupon registered in the sender's account is satisfied), and completes the sale of a product by performing a payment procedure and determining the sender's account to be a final buyer when payment information related to the cooperative buying coupon, the cooperative buying condition of which has been satisfied, is received from the first user terminal.

Alternatively, the advertisement server 20 provides a payment request, requesting the first user terminal to make a payment for the selected cooperative buying coupon within a predetermined period, to the first user terminal before the accomplishment of the cooperative buying, performs a payment procedure and registers the sender's account as a cooperative buying participant when payment information is received from the first user terminal, and determines a final buyer when the cooperative buying is accomplished or refunds the payment when the cooperative buying has failed.

The case where the cooperative buying coupon is selected using the second user terminal is the same.

Furthermore, in the above embodiment, with regard to the coupon data about the cooperative buying coupon, a minimum amount of data to be displayed on the image output unit 12 may be sent along with the moving-image advertisement at step S110, and then detailed information included in the coupon data may be sent at step S210 when the cooperative buying coupon is selected at step S115, the coupon selection information is received by the advertisement server 20 at step S125 or the termination of the video call is sensed at step S165, and also the video call termination signal is received at step S17.

It will be appreciated by those having ordinary knowledge in the art to which the present invention pertains that the present invention may be practiced in other specific forms without changing the technical spirit and essential features of the present invention. Therefore, it should be understood that the above-described embodiments are illustrative but not restrictive in any way. The scope of the present invention is defined by the scope of the following claims rather than the specification. It should be appreciated that the meanings and scope of the claims and all modifications or variations derived from the equivalents of the claims fall within the scope of the present invention.

1. A method of providing moving-image advertisements and coupons using Voice over Internet Protocol (VoIP), the method being performed by a server for providing moving-image advertisements and coupons to a plurality of user terminals capable of a video call using VoIP, the method comprising the steps of:
(a) when a video call attempt signal is received from a user terminal, sending a moving-image advertisement to the user terminal;
(b) sending coupon data about a cooperative buying coupon corresponding to the moving-image advertisement sent at step (a);
(c) when a signal indicative of selection of the cooperative buying coupon corresponding to the moving-image advertisement sent at step (a) is received from the user terminal, registering the cooperative buying coupon selected by the user terminal in a user account assigned to the user terminal;
(d) when a video call setup signal is received from the user terminal, terminating the sending of the moving-image advertisement; and
(e) when cooperative buying related to the cooperative buying coupon registered in the user account is accomplished, notifying the user terminal of the accomplishment of the cooperative buying.

2. The method according to claim 1, further comprising the steps of:
(f) when a video call termination signal is received from the user terminal, sending the coupon data about the cooperative buying coupon registered in the user account at step (c) to the user terminal; and
(g) when information about a payment for the cooperative buying coupon is received from the user terminal, completing the payment by performing a payment procedure based on the payment information, and sending coupon payment completion information to the user terminal.

3. The method according to claim 1, further comprising the step of:
(h) when the video call setup signal is received from the user terminal at step (d) and then a signal requesting the moving-image advertisement or the cooperative buying coupon to be shared with another user terminal, that is, a counter party of the video call, is received from the user terminal, sending the moving-image advertisement sent at step (a) or the coupon data sent at step (b) to the other user terminal.

4. The method according to claim 1, wherein step (a) comprises:
(a1) when a video call attempt signal is received from the user terminal, searching user accounts corresponding to identification information of the user terminal and identification information of another user terminal, that is, a counter party of the video call, included in the video call attempt signal;
(a2) searching for a moving-image advertisement corresponding to at least one of an age, a vocation, a field of interest, a place of residence and a country of residence included in user information corresponding to the searched user accounts; and
(a3) sending the retrieved moving-image advertisement to the user terminal.

5. A method of providing moving-image advertisements and coupons using Voice over Internet Protocol (VoIP), the method being performed by a server for providing moving-image advertisements and coupons to a plurality of user terminals capable of a video call using VoIP, the method comprising the steps of:
(A) when a user's video call attempt is sensed, sending a video call attempt signal to the server;
(B) when a moving-image advertisement and coupon data about a cooperative buying coupon corresponding to the moving-image advertisement are received from the server, displaying the moving-image advertisement and the cooperative buying coupon;
(C) when the cooperative buying coupon is selected, sending a signal indicative of the selection of the cooperative buying coupon to the server;
(D) when video call setup is sensed, sending a video call setup signal to the server, stopping the displaying of the moving-image advertisement and the cooperative buying coupon at step (B), and displaying a call video sent by a communication service provider server;
(E) when termination of the video call is sensed, sending a video call termination signal to the server; and
(F) when a notification of accomplishment of cooperative buying related to the cooperative buying coupon selected at step (C) is received from the server, displaying the notification of accomplishment of cooperative buying.

6. The method according to claim 5, wherein step (C) comprises the step of:
when the cooperative buying coupon is selected, storing coupon data about the selected cooperative buying coupon in the user terminal.

7. The method according to claim 5, wherein step (D) comprises the steps of:
displaying a button for sharing the moving-image advertisement or the cooperative buying coupon corresponding to the moving-image advertisement on one side of the call video while displaying the call video; and
when the button for sharing the moving-image advertisement or the cooperative buying coupon corresponding to the moving-image advertisement is selected, sending a signal requesting the moving-image advertisement or the cooperative buying coupon to be shared, including identification information of another user terminal to which a video call is set up, to the server.

8. The method according to claim 5, wherein step (D) comprises the steps of:
displaying a moving-image advertisement sharing button on one side of the call video while displaying the call video;
when the moving-image advertisement sharing button is selected, sending a moving-image advertisement sharing request signal, including identification information of another user terminal to which a video call is set up, to the server; and
when the moving-image advertisement displayed at step (B) is sent from the server in response to the sharing request signal, receiving and displaying the sent moving-image advertisement.

9. The method according to claim 5, wherein step (F) comprises the steps of:
when a cooperative buying accomplishment notification related to the cooperative buying coupon selected at step (C) is received from the server, displaying a payment window for receiving payment information for the cooperative buying coupon for which the cooperative buying has been accomplished; and
receiving the payment information using the payment window, and sending the payment information to the server.

10. A server for providing moving-image advertisements and coupons to a plurality of user terminals capable of a video call using VoIP, the server comprising:
an advertisement provision unit for providing a moving-image advertisement to the user terminal when a video call attempt signal is sent by the user terminal, and stopping the provision of the moving-image advertisement when a video call setup signal is sent;
a coupon provision unit for searching for a cooperative buying coupon corresponding to the moving-image advertisement provided to the user terminal by the advertisement provision unit, and sending coupon data about the retrieved cooperative buying coupon to the user terminal; and
a user information management unit for registering the selected cooperative buying coupon in a user account assigned to the user terminal when the user terminal receives a signal indicative of selection of the cooperative buying coupon.

11. The server according to claim 10, further comprising:
an advertisement database (DB) for storing a plurality of moving-image advertisements;
a coupon DB for storing coupon data about cooperative buying coupons respectively corresponding to the plurality of moving-image advertisements stored in the advertisement DB; and
a user DB for storing user information of user accounts respectively assigned to the user terminals.

12. The server according to claim 11, wherein the advertisement provision unit selects a moving image advertisement to be sent to the user terminal from the advertisement DB, based on user information of user accounts respectively corresponding to identification information of a sending user terminal and identification information of a receiving user terminal included in the video call attempt signal.

13. The server according to claim 11, wherein the coupon data stored in the coupon DB comprises at least part of identification information of the moving-image advertisement corresponding to the cooperative buying coupon, a product price, a discount rate, a cooperative buying condition, a coupon use condition, a number of currently issued coupons, an identification number of the coupon, and a validity period of the coupon.

14. The server according to claim 11, wherein the advertisement provision unit sends the moving-image advertisement, provided when the video call attempt signal is received, or the coupon data about the cooperative buying coupon corresponding to the moving-image advertisement, provided when the video call attempt signal is received, to the user terminal when a video call termination signal is received from the user terminal.
